(19) United States
(12) Patent Application Publication
(10) Pub. No.: US 2007/0108137 A1
(43) Pub. Date: May 17, 2007

(54) Heavy metal recovery system and method for heavy metal recovery

(76) Inventors: Shenjung Huang, Taipei (TW); Da-Jiang Chang, Taipei (TW)

Correspondence Address: SHENJUNG HUANG, 4F., NO. 177, HO PING E. RD., SEC. 2, TAIPEI, 106, TW

(21) Appl. No.: 11/590,619

(22) Filed: Nov. 1, 2006

(30) Foreign Application Priority Data
Nov. 17, 2005 (TW) 094140523

(51) Int. Cl. C01G 7/00

(52) U.S. Cl. 210/767; 423/23; 210/768

(57) ABSTRACT

A heavy metal recovery system at least includes a slurry preparation unit, a reaction unit, and a pressure filtering unit. In the slurry preparation unit, a heavy metal-containing sludge cake and/or an undiluted heavy metal sludge/slurry is mixed with an acidic etching waste liquid and/or water to form slurry. The reaction unit connects to the slurry preparation metal-containing unit for the reaction that generates a heavy metal-containing reaction product. The pressure filtering unit connects to the reaction unit, and the heavy metal-containing reaction product is pressure filtered to obtain a heavy metal-containing material.

### FIELD OF THE INVENTION

The present invention relates to a heavy metal recovery system and a process for heavy metal recovery. More specifically, the invention relates to a system and process for recovery of heavy metal, which is highly valuable, from a heavy metal-containing waste or effluent without any output of sludge and/or slurry or other secondary wastes.

### DESCRIPTION OF THE RELATED ART

As popularization and development of electronics proceed, the market value of circuit boards which are used in the electronics has exceeded over thousands dollars. However, chemicals and materials used for the manufacture of the circuit board produce a lot of poisonous wastes in either liquid form or solid form, in which heavy metals such as copper, lead or nickel are contained. If such great amount of heavy metals cannot be well treated, then serious environmental pollution will occur to endanger human's health.

Regarding to the treatment of copper-containing wastewater or wastes, most of the wastes from the manufacture of the printed circuit board (PCB) is currently de-watered and neutralized before being charged to meet environmental protection regulations. That means the wastes do not disappear, but change its water content or pH value instead to reduce the impact to the environment. On the other hand, the manufacturer must pay outsourcing professional waste treatment companies for further treatment of these wastewater or wastes, which makes the waste treatment cost getting or recycle the wastes becomes more critical to the environmental protection.

In addition, the manufacture of PCB utilizes a number of processes which use various strong acids and/or strong alkali and result in wastes from these processes are different in contents, concentrations and species percentage. Various approaches have been proposed for treating these process wastes.

For example, it is reported that a waste liquid containing copper chloride is be mixed with alkali solution to obtain copper oxide. JP patent no. 2002-211920 discloses recovery of copper oxide from a copper chloride etching waste liquid. The etching waste is mixed with an aqueous alkaline solution of over pH 11 at 50° C. Copper ions dissolved in the mixed solution transform into copper oxide after sedimentation. This disclosure is incorporated herein by reference.

TW patent no. 580484 teaches a method of copper oxide recovery in which a strong acid selected from sulfuric acid, nitric acid and hydrogen chloride, and a peroxides (as a strong oxidant) are mixed with copper-containing sludge that contains polymeric coagulant to release a mixture having the polymeric coagulant and metal hydroxide. Then, the mixture is adjusted to be acidic to take the polymeric coagulant out. After the acidic liquid turns into alkali by pH adjustment, copper oxide is obtained. Other processes that use the strong oxidant to recover copper from copper-containing sludge is also disclosed in U.S. Pat. No. 6,027,543, U.S. Pat. No. 4,670,052 and GB patent no. 2,118,536. Those disclosures are incorporated herein by reference. The use of the strong oxidants generates a great number of oxidizing gases during oxidation and thus needs further installation of scrubber towers to collect those harmful gases and prevent them from spreading out over the manufacture plant.

Other technologies of recovering copper by adding a chelating agent or a chelating agent-containing polymer into a metal-containing solution or sludge to form a stable metal complex is disclosed in U.S. Pat. No. 6,896,808, for example. The disclosed is incorporated herein by reference.

Most of the above approaches still form secondary wastes after treatment. Even for TW patent no. 580484 that claims no secondary waste forms at the end of the treatment still needs an extra hood, taking into consideration that the harmful gases might come out.

In addition, all of the above processes deal with one process waste, for example, the copper sludge or slurry, the copper chloride waste solution or copper-containing etching waste liquid. Other process wastes still need to be treated by outsiders, so that the revalant cost is still significant high.

Therefore, there is a need of a waste treatment process that can deal with a plurality of different process wastes in the same treatment system without any output of secondary wastes.

### SUMMARY OF THE INVENTION

Therefore, it is an object of the invention to provide a recovery of heavy metal from heavy metal-containing wastes or liquids without any output of any secondary wastes generated during the recovery.

Another object of the invention is to provide a recovery of heavy metal from heavy metal-containing wastes or liquids in-situ in a manufacture plant where the heavy metal-containing wastes or liquids output, which would not have any outsourcing treatment cost for additional treatment of the secondary wastes.

In order to achieve the above and other objectives of the invention, a heavy metal recovery system that includes a high concentration slurry preparation unit, a reaction unit and a pressure filtering unit is provided.

In the slurry preparation unit, a heavy metal-containing sludge cake and/or an undiluted heavy metal-containing sludge/slurry are mixed with an acidic etching waste liquid and/or water while stirring to form a slurry. The reaction unit in which a heavy metal-containing reaction product (referred to as “reaction product” as well) piping connects to the slurry preparation unit. The pressure filtering unit pressure filters the reaction product from the reaction unit to obtain a heavy metal-containing material.

The heavy metal can be selected from the group of consisting of copper, tin, nickel and gold. The reaction product can be a reaction product containing copper oxide. The heavy metal-containing material can be copper oxide solid. When the heavy metal is copper, the percentage of copper in copper oxide solid is at least 22%.

In one preferred embodiment, the slurry preparation unit at least includes a stirring tank equipped with a stirrer. The slurry preparation unit can optionally include a slurry storage unit connecting to the stirring tank for storing high concentration slurry formed in the stirring tank.

In another embodiment, the stirring tank at least includes a sludge cake inlet, a first water input pipe and a high concentration slurry piping.

In still another embodiment, the stirring tank at least includes a sludge cake inlet, an acidic photolithography wastes liquid piping and a high concentration slurry piping.

In another embodiment, the stirring tank at least has a sludge cake inlet, a first water input pipe, and an acidic photolithography waste liquid piping and a high concentration slurry piping.

The reaction unit at least includes a reactor, and optionally a reaction product storage container connected to the reactor. The reactor at least has a liquid alkali piping and a copper chloride waste solution piping, and connects to the high concentration slurry piping. The reactor optionally includes a second water input pipe to adjust the concentration of reactants in the reactor, and/or an undiluted heavy metal-containing sludge/slurry (“undiluted sludge/slurry” hereafter as well) piping connecting to the reactor for charging the undiluted sludge/slurry into the reactor, and/or an acidic photolithography waste liquid piping for charging the acidic photolithography waste liquid into the reactor to reduce the pH vale in the reactor.

The pressure filtering unit is a device used for solid-liquid separation under pressure, such as a press. The pressure filtering unit is operated at pressure more than 6 KG of pressure. It at least has a heavy metal-containing material piping and a filtrate piping. The heavy metal-containing material piping is a copper oxide solid piping.

According to one aspect of the invention, a process for heavy metal recovery at least includes preparing a high concentration slurry; reacting the high concentration slurry with a liquid alkali and a copper chloride waste solution to obtain a reaction product; and pressure filtering the reaction product to obtain a heavy metal-containing material.

At the step of preparing the high concentration slurry, the high concentration slurry is obtained by mixing a sludge cake and/or an undiluted sludge/slurry with an acidic photolithography waste liquid and/or water.

At the reaction step, a high concentration slurry is mixed with a liquid alkali and a copper chloride waste solution to obtain a heavy metal-containing reaction product in liquid form. In one preferred embodiment, the liquid alkali, the copper chloride waste solution and the high concentration slurry are added in sequence. The reaction time depends on the pH values and the contents of each reactant. During the reaction, the pH value for the reaction is kept at higher than 9.5.

The heavy metal can be selected from the group of consisting of copper, tin, nickel and gold. The reaction product can be a reaction product containing copper oxide. The heavy metal-containing material can be copper oxide solid. When the heavy metal is copper, the percentage of copper in copper oxide solid is at least 22%.

After the pressure filtering step, a heavy metal-containing material and filtrate are obtained. The filtrate can be recycled to a pH adjustment pool of a wastewater treatment unit of the manufacture plant that generate the sludge cake, undiluted sludge/slurry and copper chloride waste solution, so as to save a part of usage of the liquid alkali in the process of the invention.

The water used in the invention can be tap-water or the filtrate generated at the pressure filtering step.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a flow chart of a heavy metal recovery system according to a preferred embodiment of the invention.

### DETAILED DESCRIPTION OF THE EMBODIMENT(S)

Among of process units of a typical PCB manufacture process, those generating a lot of heavy metal-containing wastes includes units of etching an inner layer and an outer layer of a circuit board, manufacturing lead frame and photolithography.

Etchants used to etch the inner/outer layers of the circuit board include ion chloride, copper chloride, ammonium chloride and ammonia. Therefore, the waste liquid generated in this etching process includes ion chloride, copper chloride and ammonium chloride. Compounds used in the photolithography process include sulfur acid/hydrogen peroxide, sodium persulfate and ammonium persulfate. A lead frame manufacture process mainly uses strong acid such as nitric acid. The operations and conditions in the above manufacture processes are well known in the art so that the detailed description thereof is omitted here.

A PCB manufacture plant typically has a wastewater treatment unit for roughly treating various process waste liquids or water before those waste liquids are discharged or sent out for further treatment. The waste liquid or water includes a number of heavy metals such as copper, tin, or lead. A waste mixture collected in the wastewater treatment unit come from various manufacture processes and has a pH value of 2-3 that usually increases to 7-9 by adding iron chloride. A polymeric coagulant is added into the waste mixture later to form sludge which thus contains several heavy metals. After pressure filtering, a sludge cake of more than 70% water is obtained. The filtrate then meets the discharge standard about pH values and pollutant concentration.

The waste/effluent to be treated in the treatment process or the treatment system according to the invention includes copper chloride waste solution, acidic photolithography waste liquid, sludge cake and/or undiluted sludge/slurry. Optionally, high concentration nitric acid liquid and copper-containing solid waste can be also treated in the process and system according to the invention.

The term “copper chloride waste solution” used herein refers to all the copper chloride-containing waste liquid/solution that possibly generates in any of manufacture processes in the production of PCB. For example, it can be waste liquids that generate in etching the inner layer and outer layer of PCB. The copper chloride waste solution has pH of more than 0.1, and contains copper chloride, ion chloride, ammonium chloride and so on, with 40-150 g/L of copper.

The term “acidic lithography waste liquid” refers to any acidic waste liquids generated in any PCB manufacture process that uses acidic solution or liquid for photolithography. The acidic photolithography waste liquid comes from, for example, black/brown oxidation, through-hole plating, circuit plating and solder plating. The acidic photolithography waste liquid has a pH value of at least 0.3. It mainly contains sulfuric acid and/or nitric acid, and has copper of at least 200 ppm. It is noted that the acidic photolithography waste liquid is different from a pure acid that is commercially available and used as a treating agent in the art. The pure strong acid has extremely strong erosion and generates a great amount of heat and smokes that make the operating environment very dangerous. However, the acidic photolithography waste liquid used in the invention will not generate a lot of smokes and is not as highly erosive as the pure strong acid used in the art. In other words, the acidic photolithography waste liquid, in light of operating safety, is much safer than the pure strong acid in heavy metal recovery.

The term “high concentration strong acid waste liquid” used in the invention refers to an undiluted high-concentration strong acid waste liquid generated in any PCB manufacture processes, such as acidic photolithography process and lead frame manufacture. The high concentration strong acid waste liquid includes nitric acid-containing waste solution, sulfuric acid-containing waste solution and hydrogen chloride-containing waste solution.

The term “copper-containing solid waste” used in the invention refers to copper scraps resulting from cutting copper foils, laminating, shaping, trimming and quality control testing.

The term “liquid alkali” used in the invention refers to more than about 30% liquid strong alkali, such as sodium hydroxide and potassium hydroxide liquids.

The term “undiluted sludge/slurry” used in the invention refers to the one obtained by adding polymeric aggregators into a PCB wastewater treatment unit under alkaline condition. The undiluted sludge/slurry has 3-5% of copper content.

The term “sludge cake” used in the invention refers to a solid in form of cake, which is obtained after pressure filtering and has more than 50% of water and more than about 7% of copper.

The process for heavy metal recovery at least includes preparing a high concentration slurry; reacting the high concentration slurry with a liquid alkali and a copper chloride waste solution to form a reaction product; and pressure filtering the reaction product to obtain a heavy metal-containing material.

At the step of preparing the high concentration slurry, the high-concentration slurry is obtained by mixing a sludge cake and/or an undiluted sludge/slurry with an acidic photolithography waste liquid and/or water. The concentration of high concentration slurry is not particularly limited, as long as of it can be stirred and pumped to a reaction unit. The undiluted sludge/slurry can be added in at this step to increase the content of heavy metal in the high-concentration slurry and consume the undiluted sludge/slurry.

At the reaction step, the liquid alkali, copper chloride waste solution and the high-concentration slurry are charged into the reaction unit, preferably with stirring. The sequence of adding the liquid alkali, copper chloride waste solution and the high-concentration slurry is not particularly limited. In one preferred embodiment, the liquid alkali, copper chloride waste solution and the high-concentration slurry are added in sequence. In another embodiment, the liquid alkali, copper chloride waste solution and the high-concentration slurry react with one another under alkali condition for at least 5 minutes.

During the reaction of the liquid alkali, copper chloride waste solution and the high-concentration slurry, the reaction unit continues stirring in order to have the liquid alkali, copper chloride waste solution and the high-concentration slurry react thoroughly. The pH value of a reaction mixture of the liquid alkali, copper chloride waste solution and the high concentration slurry during the reaction is preferably controlled higher than 9.5. Since a significant amount of liquid alkali is used for this reaction, the acidic photolithography liquid can be used to control the pH of the reaction mixture.

Liquid heavy metal-containing reaction product is pressure filtered to obtain a heavy metal-containing material and a filtrate. The pH value of the filtrate can be adjusted to comply with the statutory discharge requirement, or adjusted to higher than pH 9.5 and then recycled to a wastewater treatment unit for decrease in the use of liquid alkali for wastewater treatment.

The term “heavy metal-containing material” used in the invention refers to a solid containing at least one heavy metal in any form, such as in form of oxide. The above heavy metal is at least one selected from the group consisting of copper, tin, nickel and gold. It is understood that the heavy metal-containing material after pressure filtering contains other impurities in addition to the recited heavy metals.

According to one embodiment of the invention, the heavy metal to be recovered is copper. The reaction product is a reaction product containing copper oxide. The heavy metal-containing material is copper oxide solid. In other words, a copper-containing sludge cake and/or undiluted copper-containing sludge/slurry from PCB manufactory mix with an acidic photolithography waste liquid and/or water to form high concentration copper-containing slurry. The high-concentration copper-containing slurry reacts with the liquid alkali and the copper chloride waste solution to form a copper-containing reaction product. After pressure filtering, a copper oxide solid with more than 25% of copper is obtained.

According to another embodiment of the invention, the heavy metal to be recovered is copper. The reaction product is a reaction product containing copper oxide. The heavy metal-containing material is copper oxide solid. In other words, a copper-containing sludge cake and/or undiluted copper-containing sludge/slurry from PCB manufactory mix with an acidic photolithography waste liquid and/or water to form high concentration copper-containing slurry. Copper scraps are added while the copper-containing sludge cake and/or undiluted copper-containing sludge/slurry is mixing with an acidic photolithography waste liquid and/or water to increase the copper content in the high-concentration slurry and consume the undiluted copper-containing sludge/slurry. Then the high-concentration copper-containing slurry reacts with the liquid alkali and the copper chloride waste solution to form a copper-containing reaction product. After pressure filtering, a copper oxide solid is obtained.

According to another embodiment of the invention, the heavy metal to be recovered is copper. The reaction product is a reaction product containing copper oxide. The heavy metal-containing material is copper oxide solid. In other words, a copper-containing sludge cake and/or undiluted copper-containing sludge/slurry from PCB manufactory mix with an acidic photolithography waste liquid and/or water to form high concentration copper-containing slurry. The high-concentration copper-containing slurry reacts with the liquid alkali and the copper chloride waste solution to form a copper-containing reaction product. After pressure filtering, a copper oxide solid and a filtrate are obtained. The filtrate has a pH value of higher than 9.5 and can be recycled to a wastewater treatment unit of the PCB manufactory for decrease in the use of liquid alkali.

According to still another embodiment of the invention, the heavy metal to be recovered is copper. The reaction product is a reaction product containing copper oxide. The heavy metal-containing material is copper oxide solid. In other words, a copper-containing sludge cake and/or undiluted copper-containing sludge/slurry from PCB manufactory mix with an acidic photolithography waste liquid and/or water to form high concentration copper-containing slurry. The high concentration copper-containing slurry reacts with the liquid alkali and the copper chloride waste solution to form a copper-containing reaction product. A copper solution formed by dissolving copper scraps with high concentration strong acid waste liquid can be further added for the above reaction to increase the yield of copper recovery. After pressure filtering, a copper oxide solid with more than 25% of copper is obtained.

The term “copper oxide solid” here refers to solids containing copper oxide and other impurities such as iron, tin and lead and so on. Therefore, “copper oxide solid with more than 25% of copper” here refers to the percentage of metal copper or copper oxide in weight based on the total weight of copper oxide solid is more than 25%.

This invention also provides a heavy metal recovery system that includes a high concentration slurry preparation unit, a reaction unit and a pressure filtering unit.

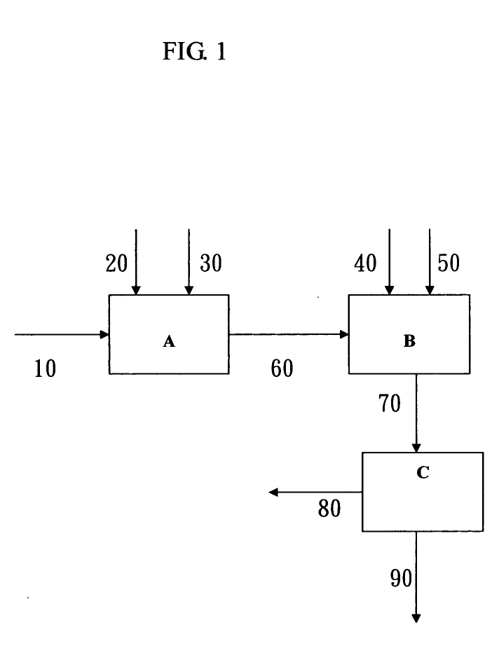

FIG. 1 is a flow chart of schematic view of a heavy metal recovery system according to a preferred embodiment of the invention. Referring to FIG. 1, the heavy metal recovery system according to the invention includes a high concentration slurry preparation unit A, a reaction unit B and a pressure filtering unit C. In the high concentration slurry preparation unit A, the heavy metal-containing sludge cake and/or the undiluted heavy metal-containing slurry mix with the acidic photolithography waste liquid and/or water to form the high concentration slurry. The reaction unit B connects to the high concentration slurry preparation unit A. In the reaction unit B, the liquid alkali, the copper chloride waste solution and the high concentration slurry are respectively charged to form the heavy metal-containing reaction product. The pressure filtering unit C connects to the reaction unit B and outputs the heavy metal-containing material.

The high concentration slurry preparation unit A includes at least a stirring unit with a stirrer (not shown), and further a high concentration slurry storage container (not shown) connected to the stirrer for storing the high concentration slurry formed in the stirrer. The high concentration slurry preparation unit A includes a sludge cake inlet 10, a first water input pipe 20, an acidic photolithography wastes liquid piping 30 and a high concentration slurry piping 60. In that case that the high concentration slurry preparation unit A includes the stirrer and the high concentration slurry storage unit, the stirrer connects to the sludge cake inlet 10, the first water input pipe 20 and the acidic photolithography wastes liquid piping 30, the high concentration slurry storage container connects to the high concentration slurry piping 60, and a connection pipe (not shown) connects the stirrer to the high concentration slurry storage container.

During preparing the high concentration slurry, in order to thoroughly dispense the sludge cake, the water input pipe 20 and/or acidic photolithography wastes liquid piping 30 charge water and/or acidic photolithography wastes liquid into the stirrer first and then the sludge cake piping 30 is allowed to input the sludge cake to the stirrer. The water from the water input pipe 20 is not limited to tap-water, and water recovered from any other processes of printed circuit board manufacture or recovered by the inventive process can be used as well.

It is noted that the acidic photolithography wastes liquid has pH value greater than zero. A great amount of acidic photolithography wastes liquid generated in the printed circuit board manufacture process is mixed with the sludge cake in this embodiment. In another embodiment, the sludge cake is mixed with water or with the mixture of water and the acidic photolithography wastes liquid. It is different from the prior art that uses high concentration strong acid which of pH value is so small (smaller than zero) that no pH detector can read the pH value to crack or dissolve the sludge.

The high concentration slurry piping 60 connects to the reaction unit B. The reaction unit B includes a reactor (not shown) which can be further mounted with a stirrer (not shown) for complete reaction. The reaction unit B further includes a heavy metal-containing reaction product storage container which connects to the reactor. The reactor further has, in addition to the high concentration slurry piping 60, a liquid alkali liquid piping 40, a copper chloride piping 50, and a heavy metal-containing reaction product piping 70. In the case that the reaction unit includes the reactor and the heavy metal-containing reaction product storage container, the reactor connects to the high concentration slurry piping 60, the liquid alkali piping 40 and the copper chloride piping 50, and the heavy metal-containing reaction product storage container connects to the heavy metal-containing reaction product piping 70, with a connection pipe between the reactor and the heavy metal-containing reaction product piping 70. A second water input pipe (not shown) can be further mounted to connect to the reactor B for adjusting reactant concentration inside the reactor.

The liquid alkali, copper chloride liquid and the high concentration slurry are in turns input in the reactor respectively through the liquid alkali piping 40, the copper chloride liquid piping 50 and the high concentration slurry piping 60. After a certain period of time, the heavy metal-containing reaction product in liquid form is generated. In consideration of any adverse effect of reaction heat being released during reaction, the heavy metal-containing reaction product thus formed preferably cools down in a heavy metal-containing reaction product container (not shown) before goes to the pressure filter C through the heavy metal-containing reaction product piping 70.

In order to increase the yield of recovering heavy metal and the performance of processing remaining sludge, an undiluted heavy metal-containing sludge piping 11 can be further mounted to connect to the reactor to charge the heavy metal-containing slurry into the reactor. Furthermore, another undiluted heavy metal-containing sludge piping is optionally mounted to connect to the stirrer so that the heavy metal content in the high concentration slurry can be higher. In this case, high concentration slurry formed in the stirrer can be stored in advance in the high concentration slurry storage container connected to the stirrer.

Furthermore, high concentration strong acid waste liquid generated in acidic photolithography processes and leadframe processes can be used to dissolve copper-containing solid wastes in advance to form a copper solution which is then pour into the reactor to increase copper recovery.

A lot of liquid alkali is added into the reactor. In order to control the pH value of content inside the reactor within a predetermined range, an acidic photolithography waste liquid piping can be further mounted to charge the acidic photolithography waste liquid into the reactor.

The pressure filtering unit C can be a device which is conventionally used to perform solid/liquid separation by using pressure. The operation pressure of the pressure filtering unit C is at least 6 kg. The pressure filtering unit C includes a heavy metal-containing material piping 80 and a filtrate piping 90. The heavy metal-containing reaction product is pressure filtered to obtain a heavy metal-containing material and a filtrate. The heavy metal-containing material is taken from the heavy metal-containing piping 80 as an industrial raw material of high economic value. The filtrate is drawn out from the filtrate piping 90 and recycled back to the slurry preparation unit A through the water input pipe 20, fed to the reactor B for the purpose of concentration adjustment, or recycled back to a pH value adjusting pool of the wastewater treatment unit in situ in replace of part of the use of liquid alkali.

The heavy metal recited above is one selected from the group of consisting of copper, tin and nickel.

In one preferred embodiment, when the heavy metal to be recovered is copper, the heavy metal-containing reaction product is copper oxide-containing reaction product and the heavy metal-containing material is copper oxide solid. An undiluted copper-containing sludge piping as shown by the reference numeral 11 in FIG. 1 connects to the stirrer to charge the copper-containing sludge into stirrer to increase copper content of the high concentration slurry formed in the slurry preparation unit A.

In another preferred embodiment of the invention, when the heavy metal to be recovered is copper, the heavy metal-containing reaction product is copper oxide-containing reaction product and the heavy metal-containing material is copper oxide solid. The heavy metal-containing reaction product is pressure filtered to obtain copper oxide solid and filtrate. Copper oxide solid is taken out of the copper oxide solid piping 80. The filtrate is taken out of the filtrate piping 90, recycled back to slurry preparation unit A through water input pipe 20, fed to the reactor B for the purpose of concentration adjustment, or recycled back to a pH value adjusting pool of the wastewater treatment unit in situ in replace of liquid alkali.

The terms “inlet”, “piping” and “input pipe” used here are referred to pipe, pipeline, tube or other conveying device which can transport liquid or solid substances and be anti-erosion and anti-chemical. The piping or input pipe used here convey designated substances in manual or automatic way through respective control units such as control valves or controllers for more precise control of the conveyed amount.

### EXAMPLE 1

Acidic photolithography waste liquid of about 4000 kg and copper-containing sludge cake of about 1000 kg are mixed in a stirrer to form high concentration copper-containing slurry.

Liquid alkali of about 600 kg, copper chloride of about 1000 kg and high concentration copper-containing slurry thus formed of about 5000 kg are input into a reactor of 15 tones. After reaction is completed, reaction products are sent to a filtering unit. Copper oxide solid of about 384 kg and filtrate of about 6100 kg are obtained. The percentage of copper based on the total weight of copper oxide solid is about 40 wt %.

### EXAMPLE 2

Tap-water/filtrate mixture of 4000 kg and copper-containing sludge cake of 1000 kg are mixed in a stirrer to form high concentration copper-containing slurry.

Liquid alkali of about 600 kg, copper chloride of about 1000 kg and high concentration copper-containing slurry thus formed of about 5000 kg are input into a reactor of 15 tones. After reaction is completed, reaction products are sent to a filtering unit. Copper oxide solid of about 540 kg and filtrate of about 6020 kg are obtained. The percentage of copper based on the total weight of copper oxide solid is about 26 wt %.

### EXAMPLE 3

Acidic photolithography waste liquid of about 3500 kg, filtrate of about 500 kg and copper-containing sludge cake of about 1000 kg are mixed in a stirrer to form high concentration copper-containing slurry.

Liquid alkali of about 600 kg, copper chloride of about 1000 kg and high concentration copper-containing slurry thus formed of about 5000 kg are input into a reactor of 15 tones. After reaction is completed, reaction products are sent to a filtering unit. Copper oxide solid of about 476 kg and filtrate of about 6080 kg are obtained. The percentage of copper based on the total weight of copper oxide solid is about 32 wt %.

In light of foregoing, in the heavy metal recovery system and process of the invention, all treatment agents used to treat the wastewater, waste liquid or solid wastes come from the wastewater, waste liquid and solid wastes themselves, except liquid alkali. Therefore, treatment of almost the wastes generated in the printed circuit board manufacture plant can work out at once. In terms of economic effects, the cost of liquid alkali is low while the recovered copper oxide has very high economic value as raw material of copper refining.

Compared to the conventional copper recovery method using strong acid and strong oxidant, no strong oxidant is needed in the invention. Instead, the sludge cake and/or sludge turn into high concentration copper-containing slurry which is able to be stirred for reaction directly. Therefore, not only the purchase cost of strong oxidant can be cut off but also the concerns that gases generated from the highly oxidizable strong oxidants may hurt human health and endanger environmental safety.

Furthermore, the acidic photolithography waste liquid used in the invention does not generate a lot of smokes while has weaker erosion than unused strong acid, which renders the operation of the inventive process more safe than the prior art.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A heavy metal recovery system, comprising
a slurry preparation unit, wherein a heavy metal-containing sludge cake and/or an undiluted heavy metal-containing sludge/slurry are mixed with an acidic etching waste liquid and/or water while stirring to form a high concentration slurry;
a reaction unit, connected to the high concentration slurry preparation unit, wherein
a heavy metal-containing reaction product is output; and
a pressure filtering unit, connected to the reaction unit, wherein the heavy metal-containing reaction product is pressure filtered to obtain a heavy metal-containing material.

2. The system of claim 1, wherein the high concentration slurry preparation unit at least includes a stirring tank equipped with a stirrer.

3. The system of claim 3, wherein the high concentration slurry preparation unit further includes a high concentration slurry storage unit connecting to the stirring tank for storing high concentration slurry formed in the stirring tank.

4. The system of claim 3, wherein the stirrer at least includes a sludge cake inlet, a first water input pipe and a high concentration slurry piping.

5. The system of claim 3, wherein the stirring tank at least includes a sludge cake inlet, an acidic photolithography wastes liquid piping and a high concentration slurry piping.

6. The system of claim 3, wherein the stirring tank at least has a sludge cake inlet, a first water input pipe, and an acidic photolithography waste liquid piping and a high concentration slurry piping.

7. The system of claim 3, wherein the stirrer further has an undiluted sludge/slurry piping.

8. The system of claim 3, wherein the high concentration slurry piping connects to the reaction unit.

9. The system of claim 1, wherein the reaction unit at least includes a reactor, and optionally a reaction product storage container connected to the reactor.

10. The system of claim 1, wherein the reaction unit at least has a liquid alkali piping and a copper chloride waste solution piping, and connects to the high concentration slurry piping.

11. The system of claim 1, wherein the reaction unit further includes a second water input pipe to adjust the concentration of reactants in the reactor.

12. The system of claim 1, wherein the reaction unit further has an undiluted heavy metal-containing sludge/slurry piping connecting to the reactor for charging the undiluted sludge/slurry into the reactor.

13. The system of claim 1, wherein the reaction unit further has an acidic photolithography waste liquid piping for charging the acidic photolithography waste liquid into the reactor to reduce the pH vale in the reactor.

14. A process for heavy metal recovery at least comprising:
a) preparing a high concentration slurry by mixing a heavy metal-containing sludge cake and/or undiluted heavy metal-containing sludge/slurry with an acidic photolithography waste liquid and/or water;
b) reacting the high concentration slurry with a liquid alkali and a copper chloride waste solution to obtain a reaction product; and
c) pressure filtering the reaction product to obtain a heavy metal-containing material and a filtrate.

15. The process of claim 14, wherein the reaction product is a reaction product containing copper oxide.

16. The process of claim 14, wherein the heavy metal-containing material is copper oxide solid.

17. The process of claim 14, wherein the weight percentage of copper base on the total weight of copper oxide solid is at least 22%.

18. The process of claim 14, wherein at step c), the reaction product is pressure filtered at pressure of at least 7 kg.

19. The process of claim 14, wherein at step b), mixture of the high concentration slurry, liquid alkali and copper chloride waste solution has pH of more than 9.5.

20. The process of claim 14, wherein the water used at step a) is tap-water or the filtrate obtained in step c).
